(19) United States
(12) Patent Application Publication
(10) Pub. No.: US 2016/0103688 A1
(43) Pub. Date: Apr. 14, 2016

(54) Method of Starting Computing System

(71) Applicants: Inventec (Pudong) Technology Corp., Shanghai (CN); Inventec Corporation, Taipei (TW)

(72) Inventors: XiLang Zhang, Shanghai (CN); Peng Hu, Shanghai (CN)

(21) Appl. No.: 14/582,138

(22) Filed: Dec. 23, 2014

(30) Foreign Application Priority Data
Oct. 14, 2014 (CN) 201410539490.2

(51) Int. Cl. G06F 9/44; G06F 1/14

(52) U.S. Cl. CPC G06F 9/4401; G06F 1/14

(57) ABSTRACT

The present disclosure provides a method of starting a computer system. The method includes rebooting a baseboard management controller of the computer system; the baseboard management controller loading a real time clock driver, wherein the real time clock driver is used for enabling a real time clock function; checking a field of a real time clock register after the real time clock driver loaded; enabling a real time clock update filed and clearing a time tag of the real time clock register if a state of the field of the real time clock register is disable; the baseboard management controller obtaining the time tag from the real time clock register; and the baseboard management controller completing a start process if the time tag is later than a predefined time.

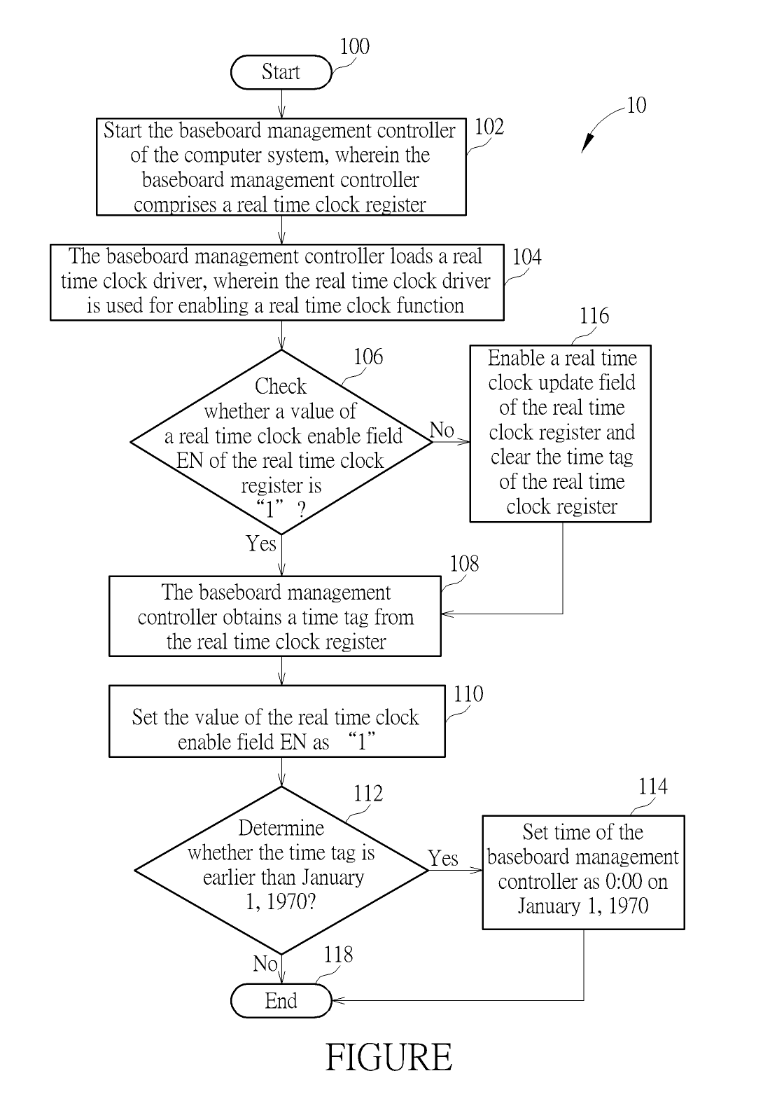

### BACKGROUND OF THE INVENTION

1. Field of the Invention

The present invention relates to a starting method of a computer system, and more particularly, to a starting method capable of resolving an abnormality of a computer system caused by an AC power source being cut off.

2. Description of the Prior Art

A baseboard management controller (BMC) manages a whole computer system through interfaces. For example, the baseboard management controller may perform system status detection and event filtering, power management, event time recording and system recovery control, and inform administrators via a network or a serial connection. In addition, the baseboard management controller provides an intelligent platform management bus (IPMB) to communicate with external management controllers.

During a process of a power-on self-test (POST), a basic input output system (BIOS) would send a system date and time to the baseboard management controller. The baseboard management controller stores the date and time to a real time clock register. A time value in the real time clock register would be updated as time passes, so as to retain a correct time value. While a firmware of the baseboard management finishes an on-line update process and the baseboard management controller is rebooted, the baseboard management controller would access the time value from the real time clock register. In such a situation, the time tag is ensured to be correct when the baseboard management controller records following event log.

However, after the computer system experiences an AC power cycle, since the AC power is cut off, the date and time in the real time clock register is incorrect. Although the baseboard management controller has some sieving procedure to sieve the time values in the real time clock register, not all the incorrect time values are ensured to be sieved. Therefore, during a start process of the baseboard management controller, the baseboard management controller may access the incorrect time.

### SUMMARY OF THE INVENTION

It is therefore a primary objective of the present invention to provide a starting method of a computer system capable of resolving an abnormality of the computer system.

The present invention discloses a starting method of a computer system, the computer system comprising a baseboard management controller, the starting method comprising starting a baseboard management controller of the computer system, wherein the baseboard management controller comprises a real time clock register; the baseboard management controller loading a real time clock driver, wherein the real time clock driver is used for enabling a real time clock function; checking a real time clock enable field of the real time clock register of the baseboard management controller after the real time clock driver is loaded; enabling a real time clock update field of the real time clock register and clearing a time tag of the real time clock register if a state of the real time clock enable field of the real time clock register is disable; the baseboard management controller obtaining the time tag from the real time clock register; and the baseboard management controller completing a start process if the time tag is later than a predefined time.

In an embodiment, if the state of the real time clock enable field of the real time clock register is enable, the baseboard management controller obtains the time tag from the real time clock register directly.

In an embodiment, if the time tag is earlier than the predefined time, the time tag is set as the predefined time, and the baseboard management controller completes the start process.

In an embodiment, further comprising after the baseboard management controller completes the start process, the computer system starting a power-on self-test (POST), a basic input output system (BIOS) delivering a system time to the baseboard management controller, and the baseboard management controller storing the system time in the real time clock register to update the time tag.

In an embodiment, the start of the baseboard management controller is a booting after an AC power is supplied, an initial value of the time tag in the real time clock register is a random time, the real time clock enable field is defaulted as disable, the baseboard management controller of the computer system is started, the baseboard management controller loads the real time clock driver, the real time clock enable field of the real time clock register of the baseboard management controller is checked after the real time clock driver is loaded, since the real time clock enable field is defaulted as disable, the real time clock update field of the real time clock register is enabled and the random time in the time tag of the real time clock register is cleared, the baseboard management controller obtains the time tag from the real time clock register, the time tag is earlier than the predefined time, the time tag is set as the predefined time, and the baseboard management controller completes the start process.

In an embodiment, since the time tag is set as the predefined time, the baseboard management controller uses the predefined time to record event log.

In an embodiment, the start of the computer system is a rebooting of the computer system when the baseboard management controller of the computer system is power supplied, the state of the real time clock enable field of the real time clock register is enable, the baseboard management controller obtains the time tag from the real time clock register directly, the time tag later than the predefined time is correct, and the baseboard management controller uses the correct time tag to record event log.

In an embodiment, the start of the computer system is a rebooting of the computer system when a firmware of the baseboard management finishes an update process, the state of the real time clock enable field of the real time clock register is enable, the baseboard management controller obtains the time tag from the real time clock register directly, the time tag later than the predefined time is correct, and the baseboard management controller uses the correct time tag to record event log.

In an embodiment, the predefined time is 0:00 on Jan. 1, 1970.

In an embodiment, a field value of the state the real time clock enable field is 0 when the state the real time clock enable field is disable, the field value of the state the real time clock enable field is 1 when the state of the real time clock enable field is enable, a field value of a state the real time clock update field is 0 when the state the real time clock update field is disable, and the field value of the state the real time clock update field is 1 when the state of the real time clock update field is enable.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The FIGURE is a schematic diagram of a starting process according to an embodiment of the present invention.

### DETAILED DESCRIPTION

Please refer to the FIGURE, which is a schematic diagram of a starting process 10 according to an embodiment of the present invention. The starting process 10 is utilized in a computer system, and the computer system comprises a baseboard management controller. The starting process 10 comprises following steps:

Step 100: Start.

Step 102: Start the baseboard management controller of the computer system, wherein the baseboard management controller comprises a real time clock register.

Step 104: The baseboard management controller loads a real time clock driver, wherein the real time clock driver is used for enabling a real time clock function.

Step 106: After the real time clock driver is loaded, check whether a value of a real time clock enable field EN of the real time clock register is “1”? If yes, go to Step 108; if not, go to Step 116.

Step 108: The baseboard management controller obtains a time tag from the real time clock register.

Step 110: Set the value of the real time clock enable field EN as “1”.

Step 112: Determine whether the time tag is earlier than Jan. 1, 1970? If yes, go to Step 114; if not, go to Step 118.

Step 114: Set time of the baseboard management controller as 0:00 on Jan. 1, 1970.

Step 116: Enable a real time clock update field of the real time clock register and clear the time tag of the real time clock register.

Step 118: End.

According to the starting process 10, after the real time clock driver is loaded, the start of the baseboard management controller is determined to be a booting triggered by turning on an originally off AC power when the value of the real time clock enable field EN is read as “0”, or the start of the baseboard management controller is determined to be a manual rebooting or an automatic rebooting after the baseboard management controller finishes an on-line update process when the value of the real time clock enable field EN is read as “1”. When the baseboard management controller is booted which is triggered by turning on the originally off AC power and the real time clock driver is loaded, a real time clock function is disable. That is, the time tag in the real time clock register is incorrect. Through Step 116, the real time clock update field of the real time clock register is enabled, and the time tag of the real time clock register is cleared. The baseboard management controller obtains the cleared time tag from the real time clock register, to avoid that the baseboard management controller accesses the wrong time tag. On the other hand, when the baseboard management controller is rebooted either manually or automatically while the baseboard management controller finishes an on-line update process and the real time clock driver is loaded, the real time clock function is enabled. Therefore, the time tag in the real time clock register is correct. The baseboard management controller may obtain a plurality of time tags directly. Since the baseboard management controller starts counting how many second counts starting from 0:00 on Jan. 1, 1970, time tags earlier than 0:00 on Jan. 1, 1970 are all incorrect. In such a situation, the baseboard management controller sets the time as 0:00 on Jan. 1, 1970, meaning that the baseboard management controller does not know the actual time, and waits for receiving the time delivered from a basic input output system while booting.

In short, the embodiment of the present invention performs a reasonable determination after the real time clock driver is loaded and before the time tag of the real time clock register is obtained, to ensure whether the time tag stored in the real time clock register is correct. If the time tag is correct, the time tag is remained. If the time tag is incorrect, the time tag is cleared. Therefore, the baseboard management controller reading incorrect date and time from the real time clock register due to the AC power source being cut off is avoided.

As can be seen from the above, the starting method of the present invention comprises starting a baseboard management controller of the computer system, wherein the baseboard management controller comprises a real time clock register; the baseboard management controller loading a real time clock driver, wherein the real time clock driver is used for enabling a real time clock function; checking a real time clock enable field of the real time clock register of the baseboard management controller after the real time clock driver is loaded; enabling a real time clock update field of the real time clock register and clearing a time tag of the real time clock register if a state of the real time clock enable field of the real time clock register is disable; the baseboard management controller obtaining the time tag from the real time clock register; and the baseboard management controller completing a start process if the time tag is later than a predefined time. Furthermore, if the state of the real time clock enable field of the real time clock register is enable, the baseboard management controller obtains the time tag from the real time clock register directly; if the time tag is earlier than the predefined time, the time tag is set as the predefined time, and the baseboard management controller completes the start process. After the baseboard management controller completes the start process, the computer system starts a power-on self-test (POST), a basic input output system (BIOS) delivers a system time to the baseboard management controller, and the baseboard management controller stores the system time in the real time clock register to update the time tag. The start of the baseboard management controller is a booting after an AC power is supplied, an initial value of the time tag in the real time clock register is a random time, the real time clock enable field is defaulted as disable, the baseboard management controller of the computer system is started, the baseboard management controller loads the real time clock driver, the real time clock enable field of the real time clock register of the baseboard management controller is checked after the real time clock driver is loaded, since the real time clock enable field is defaulted as disable, the real time clock update field of the real time clock register is enabled and the random time in the time tag of the real time clock register is cleared, the baseboard management controller obtains the time tag from the real time clock register, the time tag is earlier than the predefined time, the time tag is set as the predefined time, and the baseboard management controller completes the start process. Since the time tag is set as the predefined time, the baseboard management controller uses the predefined time to record event log. The start of the computer system is a rebooting of the computer system when the baseboard management controller of the computer system is power supplied, the state of the real time clock enable field of the real time clock register is enable, the baseboard management controller obtains the time tag from the real time clock register directly, the time tag later than the predefined time is correct, and the baseboard management controller uses the correct time tag to record event log. The start of the computer system is a rebooting of the computer system when a firmware of the baseboard management finishes an update process, the state of the real time clock enable field of the real time clock register is enable, the baseboard management controller obtains the time tag from the real time clock register directly, the time tag later than the predefined time is correct, and the baseboard management controller uses the correct time tag to record event log. The predefined time is 0:00 on Jan. 1, 1970. A field value of the state the real time clock enable field is 0 when the state the real time clock enable field is disable, the field value of the state the real time clock enable field is 1 when the state of the real time clock enable field is enable, a field value of a state the real time clock update field is 0 when the state the real time clock update field is disable, and the field value of the state the real time clock update field is 1 when the state of the real time clock update field is enable.

In summary, the embodiment of the present invention determines whether the start of the baseboard management controller is a booting after an originally off AC power is turned on or the start of the baseboard management controller is a manual reboot or an automatic reboot after an on-line update process, by reading the value of the real time clock enable field, and determines whether to perform operations on the date and time stored in the real time clock register according to different conditions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A starting method of a computer system, the computer system comprising a baseboard management controller, the starting method comprising:
starting a baseboard management controller of the computer system, wherein the baseboard management controller comprises a real time clock register;
the baseboard management controller loading a real time clock driver, wherein the real time clock driver is used for enabling a real time clock function;
checking a real time clock enable field of the real time clock register of the baseboard management controller after the real time clock driver is loaded;
enabling a real time clock update field of the real time clock register and clearing a time tag of the real time clock register if a state of the real time clock enable field of the real time clock register is disable;
the baseboard management controller obtaining the time tag from the real time clock register; and
the baseboard management controller completing a start process if the time tag is later than a predefined time.

2. The starting method of the computer system of claim 1, wherein if the state of the real time clock enable field of the real time clock register is enable, the baseboard management controller obtains the time tag from the real time clock register directly.

3. The starting method of the computer system of claim 1, wherein if the time tag is earlier than the predefined time, the time tag is set as the predefined time, and the baseboard management controller completes the start process.

4. The starting method of the computer system of claim 1, further comprising after the baseboard management controller completes the start process, the computer system starting a power-on self-test (POST), a basic input output system (BIOS) delivering a system time to the baseboard management controller, and the baseboard management controller storing the system time in the real time clock register to update the time tag.

5. The starting method of the computer system of claim 3, wherein the start of the baseboard management controller is a booting after an AC power is supplied, an initial value of the time tag in the real time clock register is a random time, the real time clock enable field is defaulted as disable, the baseboard management controller of the computer system is started, the baseboard management controller loads the real time clock driver, the real time clock enable field of the real time clock register of the baseboard management controller is checked after the real time clock driver is loaded, since the real time clock enable field is defaulted as disable, the real time clock update field of the real time clock register is enabled and the random time in the time tag of the real time clock register is cleared, the baseboard management controller obtains the time tag from the real time clock register, the time tag is earlier than the predefined time, the time tag is set as the predefined time, and the baseboard management controller completes the start process.

6. The starting method of the computer system of claim 5, wherein since the time tag is set as the predefined time, the baseboard management controller uses the predefined time to record event log.

7. The starting method of the computer system of claim 2, wherein the start of the computer system is a rebooting of the computer system when the baseboard management controller of the computer system is power supplied, the state of the real time clock enable field of the real time clock register is enable, the baseboard management controller obtains the time tag from the real time clock register directly, the time tag later than the predefined time is correct, and the baseboard management controller uses the correct time tag to record event log.

8. The starting method of the computer system of claim 2, wherein the start of the computer system is a rebooting of the computer system when a firmware of the baseboard management finishes an update process, the state of the real time clock enable field of the real time clock register is enable, the baseboard management controller obtains the time tag from the real time clock register directly, the time tag later than the predefined time is correct, and the baseboard management controller uses the correct time tag to record event log.

9. The starting method of the computer system of claim 3, wherein the predefined time is 0:00 on Jan. 1, 1970.

10. The starting method of the computer system of claim 1, wherein a field value of the state the real time clock enable field is 0 when the state the real time clock enable field is disable, the field value of the state the real time clock enable field is 1 when the state of the real time clock enable field is enable, a field value of a state the real time clock update field is 0 when the state the real time clock update field is disable, and the field value of the state the real time clock update field is 1 when the state of the real time clock update field is enable.
